(19) United States
(12) Patent Application Publication
(10) Pub. No.: US 2024/0403645 A1
(43) Pub. Date: Dec. 5, 2024

(54) NEURAL NETWORK STRUCTURE PROPOSAL DEVICE AND NEURAL NETWORK STRUCTURE PROPOSAL METHOD

(71) Applicant: NEC Corporation, Tokyo (JP)

(72) Inventor: Yuki KOBAYASHI, Tokyo (JP)

(73) Assignee: NEC Corporation, Tokyo (JP)

(21) Appl. No.: 18/667,147

(22) Filed: May 17, 2024

(30) Foreign Application Priority Data
May 29, 2023 (JP) 2023-087411

(51) Int. Cl. G06N 3/082

(52) U.S. Cl. CPC G06N 3/082

(57) ABSTRACT

The neural network structure proposal device facilitates finding a neural network structure suitable for a device includes an operational efficiency analysis unit which calculate, for each of a plurality of layers of a neural network having different parameters, an estimated amount of execution time of the layer and operational efficiency corresponding to the computation amount per unit time on a target device, and a layer structure replacing unit which replaces the layer with the large estimated amount of execution time and low operational efficiency with another layer, and outputs neural network structure information indicating structure of the neural network.

### CROSS-REFERENCE TO RELATED APPLICATION

This application is based upon and claims the benefit of priority from the prior Japanese Patent Application No. 2023-087411, filed May 29, 2023, the entire contents of which are incorporated herein by reference.

### BACKGROUND OF THE INVENTION

### Field of the Invention

This invention relates to a neural network structure proposal device and a neural network structure proposal method that proposes a neural network structure.

### Description of the Related Art

When determining the structure of a neural network in the field of deep learning (Deep Learning), especially a deep neural network, it is important to be able to perform processing at high speed while maintaining high recognition accuracy. Hereinafter, unless otherwise specified, suppose that a neural network is a network that includes a deep neural network. The determination and improvement of the structure of a neural network is left to experts with extensive expertise and experience.

Experts tend to determine or improve the structure of a neural network with priority given to the recognition accuracy of the neural network over the execution speed on the hardware device used to realize the neural network. In other words, experts generally determine or improve the structure of a neural network with the primary focus on improving recognition accuracy.

NAS (Neural Architecture Search) is a method that can automatically search for a neural network structure.

Non-Patent Literature 1 describes a neural architecture search method that considers execution time. Non-Patent Literature 2 describes a method for performing layer pruning on a learned model while re-training.
[Non-Patent Literature 1] Mingxing Tan, et. al, “MnasNet: Platform-Aware Neural Architecture Search for Mobile”, Conference on Computer Vision and Pattern Recognition (CVPR), 2019, pp. 2820-2828
[Non-Patent Literature 2] Ariel Gordon, et. al, “MorphNet: Fast & Simple Resource-Constrained Structure Learning of Deep Networks”, Conference on Computer Vision and Pattern Recognition (CVPR), 2018, pp. 1586-1594

### SUMMARY OF THE INVENTION

As mentioned above, experts determine or improve the structure of a neural network with the primary focus on improving recognition accuracy. As a result, although recognition accuracy is improved, there is a risk that the performance of the hardware device is not fully utilized. In other words, there is a risk that a neural network structure that is not fast in execution may be configured.

The number of parameters does not necessarily correlate with the computation amount and execution speed. For example, devices such as dedicated deep learning accelerators in edge devices may be configured to improve execution speed at the expense of versatility. As a result, the device may have a biased characteristic. One example of a biased characteristic is the existence of processing strengths and weaknesses. For such reasons, it is difficult to fully utilize the processing performance of a device. In other words, the device's operational efficiency becomes low.

The operational efficiency is a computation amount that can be processed per unit of time. Indicators such as GOPS (Giga Operation Per Second) or GFLOPS (Giga Floating-point Operation Per Second) are used as the operational efficiency.

If the operational efficiency when performing operations using a certain neural network structure is equal to the peak performance (which can be expressed as GOPS or GFLOPS) of the hardware device, it can be said that the processing performance of the device is maximized. However, when the operational efficiency is significantly lower than the peak performance, the processing performance of the device is not being fully utilized.

Experts who are familiar with both device characteristics and neural networks are required to search for neural network structure with high operational efficiency suitable for devices.

In addition, there is a device in which even slight modifications to the neural network structure can significantly change the execution speed. When building neural network structures on such devices, experts need to repeat trial and error. Therefore, it is not easy for experts to obtain neural network structures with high operational efficiency.

Even when NAS is used, it is difficult to directly obtain a neural network structure that would allow for high operational efficiency at each layer.

It is an object of the present invention to provide a neural network structure proposal device and a neural network structure proposal method that can facilitate searching a neural network structure suitable for a device.

The neural network structure proposal device according to the present invention includes operational efficiency analysis means for calculating, for each of a plurality of layers of a neural network having different parameters, an estimated amount of execution time of the layer and operational efficiency corresponding to the computation amount per unit time on ae target device, and layer structure replacing means for replacing the layer with the large estimated amount of execution time and low operational efficiency with another layer, and outputting neural network structure information indicating structure of the neural network.

The neural network structure proposal method implemented in a computer, according to the present invention includes calculating, or each of multiple layers of a neural network having different parameters, an estimated amount of execution time of the layer and operational efficiency of the layer corresponding to a computation amount per unit time on a target device, and replacing the layer with the large estimated amount of execution time and low operational efficiency with another layer, and output neural network structure information indicating structure of the neural network.

The neural network structure proposal program according to the present invention causes a computer to execute calculating, or each of multiple layers of a neural network having different parameters, an estimated amount of execution time of the layer and operational efficiency of the layer corresponding to a computation amount per unit time on a target device, and replacing the layer with the large estimated amount of execution time and low operational efficiency with another layer, and output neural network structure information indicating structure of the neural network.

According to the present invention, it is possible to facilitate searching a neural network structure suitable for a device.

### BRIEF DESCRIPTION OF THE DRAWINGS

FIG. 1 It depicts a block diagram showing a configuration example of a neural network structure proposal device.

FIG. 2 It depicts an explanatory diagram showing an example of input neural network structure information.

FIG. 3 It depicts an explanatory diagram showing an example of target device characteristic information.

FIG. 4 It depicts an explanatory diagram showing an example of operational efficiency information.

FIG. 5 It depicts an explanatory diagram showing an example of layer replacement candidate information.

FIG. 6 It depicts an explanatory diagram showing an example of output neural network structure information.

FIG. 7 It depicts a flowchart showing an operation of the neural network structure proposal device.

FIG. 8 It depicts an explanatory diagram showing an example of kernel size expansion.

FIG. 9 It depicts a block diagram showing a configuration example of an information processing device that can realize the functions of the neural network structure proposal device.

FIG. 10 It depicts a block diagram showing the main part of the neural network structure proposal device.

### DESCRIPTION OF THE PREFERRED EMBODIMENTS

Hereinafter, an example embodiment of the present invention will be explained with reference to the drawings.

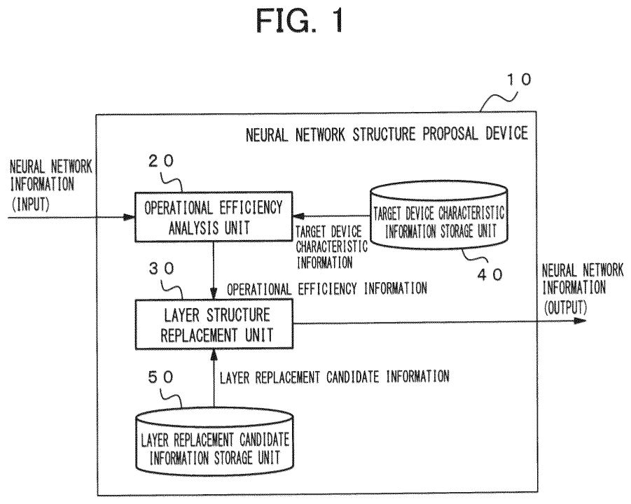

FIG. 1 is a block diagram showing a configuration example of a neural network structure proposal device. The neural network structure proposal device 10 shown in FIG. 1 includes an operational efficiency analysis unit 20, a layer structure replacement unit 30, a target device characteristic information storage unit 40, and a layer replacement candidate information storage unit 50. The target device characteristic information storage unit 40 and the layer replacement candidate information storage unit 50 may exist outside the neural network structure proposal device 10.

The operational efficiency analysis unit 20 inputs neural network structure information. Neural network structure information is information that can identify the structure of a neural network. A neural network handled in this example embodiment are mainly convolutional neural networks (CNN), but may be other types of a neural network. Hereinafter, the neural network structure information input to the operational efficiency analysis unit 20 is referred to as input neural network structure information.

The operational efficiency analysis unit 20 generates operational efficiency information using target device characteristic information stored in the target device characteristic information storage unit 40. The operational efficiency analysis unit 20 outputs the operational efficiency information to the layer structure replacement unit 30. The target device is a hardware device in which the neural network whose structure is to be determined is implemented, i.e., a hardware device for realizing a neural network.

The layer structure replacement unit 30 performs layer replacement based on the layer replacement candidate information and the operational efficiency information stored in the layer replacement candidate information storage unit 50 to generate neural network structure information. The layer structure replacement unit 30 outputs the neural network structure information. The layer replacement is, for example, to change the parameters of a layer. In other words, the layer replacement can be realized by changing the parameters. However, as described below, the layer replacement is not limited to changing the parameters of a layer, and the concept of the layer replacement may also include changing the type of a layer. Hereinafter, the neural network structure information output by the layer structure replacement unit 30 is referred to as output neural network structure information.

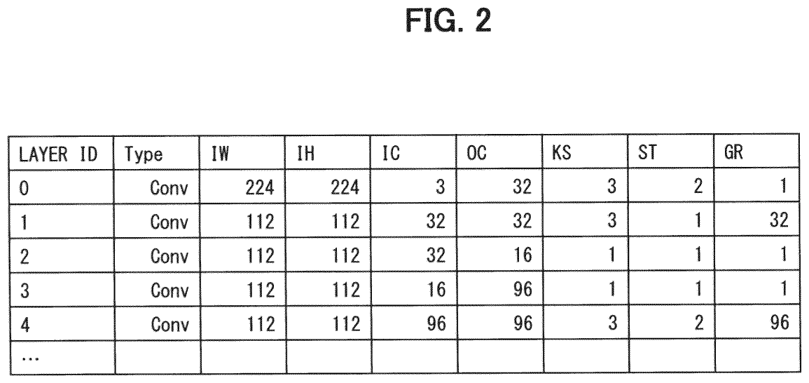

FIG. 2 is an explanatory diagram showing an example of input neural network structure information. In the example shown in FIG. 2, the neural network structure information is represented as a table of parameters for the layers in the neural network. Layers include intermediate layers (hidden layers). In the case of a CNN, there are convolution layers and the like.

In FIG. 2, ID is assigned a value to uniquely identify a layer. Type represents the type of layer. FIG. 2 shows Conv as an example of a layer type. Conv represents a convolution layer. Examples of other types of layers include Mult which represents element-by-element multiplication, Add which represents element-by-element addition, and Max Pool which represents a max pooling.

IW and IH represent the spatial size (width and height) of a layer. IC represents the number of input channels. OC represents the number of output channels. KS represents a kernel size. For example, a layer with Type=Conv and KS=3 represents a 3×3 convolutional layer. A layer with KS=1 represents a 1×1 convolutional layer.

ST represents the number of strides. The number of strides is an interval at which operations are applied. For example, stride number=1 indicates that the kernels are applied while shifting one by one. Stride number=2 indicates that the kernels are applied while shifting every other kernel.

GR represents the number of groups in Grouped Convolution. A layer with Type=Conv, GR=1 represents a convolution layer. A layer with Type=Conv, OC=32, GR=32 represents a depthwise convolution layer.

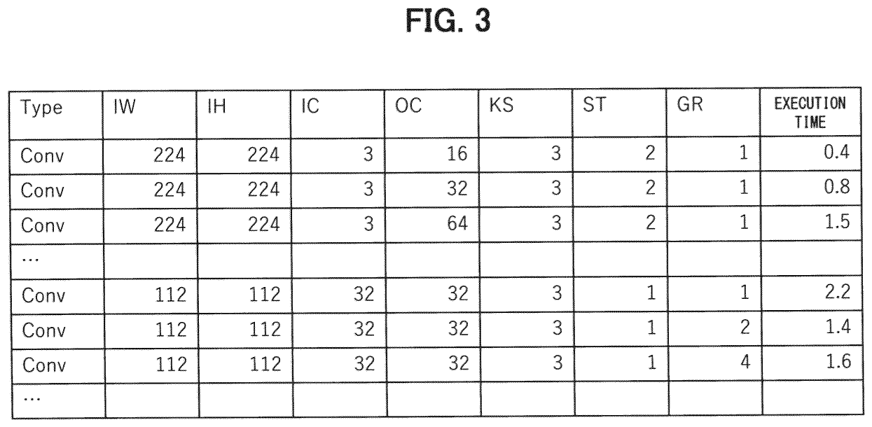

The meanings of the above symbols are the same for FIG. 3-FIG. 6.

The parameters shown in FIG. 2 are examples. Parameters may be added or deleted according to the structure of the target neural network. For example, in order to support kernel sizes other than square, the kernel size may be specified in each of the x and y directions, or the number of strides may be specified in each of the x and y directions.

FIG. 3 is an explanatory diagram showing an example of target device characteristic information. The target device characteristic information includes execution time of various layers in the target device.

For example, the first line in FIG. 3 shows an example of a layer with Type-Conv, IW=IH=224, IC=3, OC=16, KS=3, ST=2, GR=1, and an execution time of 0.4 on the target device. The unit of execution time is, for example, a millisecond. However, the unit of execution time does not have to be a millisecond. In FIG. 3, the execution time is expressed as a decimal, but it may also be expressed as an integer.

It should be noted that when the target device is changed, the contents of the target device characteristic information are replaced in advance in the target device characteristic information storage unit 40.

In addition, the target device characteristic information storage unit 40 does not necessarily need to store execution times for all parameter combinations. This is because, as described below, the operational efficiency analysis unit 20 should obtain the execution time by interpolation.

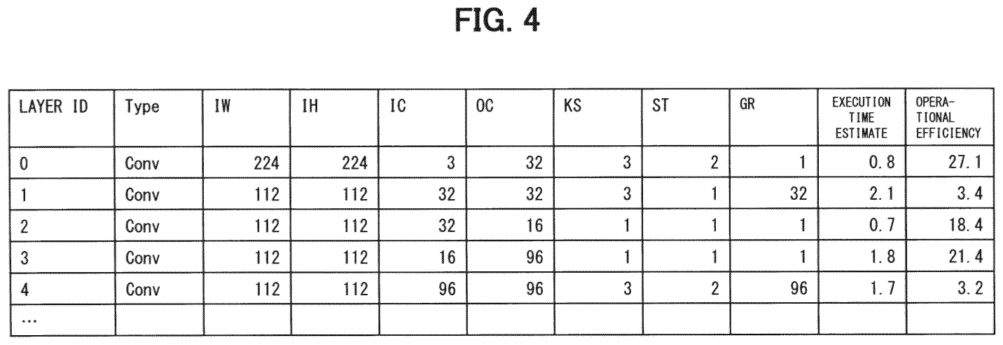

FIG. 4 is an explanatory diagram showing an example of operational efficiency information. The operational efficiency information is information in which an estimated amount of execution time (hereinafter expressed as “execution time estimate”) and operational efficiency are added to the input neural network structure information (refer to FIG. 2). The execution time estimate means the estimated execution time.

The execution time estimate is calculated by the operational efficiency analysis unit 20. Specifically, for each layer included in the input neural network structure information, the operational efficiency analysis unit 20 calculates the execution time estimate by referring to the corresponding execution time in the target device characteristic information. If the desired parameter combination exists in the target device characteristic information storage unit 40, the operational efficiency analysis unit 20 uses the corresponding execution time as the execution time estimate. When the desired parameter combination does not exist, the operational efficiency analysis unit 20 calculates the execution time estimate by interpolation based on similar parameter combinations.

For example, assume the case where the execution time for OC=24 is required, but the target device characteristic information contains only the execution time X for OC=16 and Y for OC=32. In that case, the operational efficiency analysis unit 20 should calculate the execution time estimate for the case of OC=24 by linear interpolation of X+(Y−X)*24/(32 −16).

Depending on the type of parameters and device characteristics, the operational efficiency analysis unit 20 may perform quadratic interpolation, etc., instead of linear interpolation. The interpolation method depending on the parameter and device, for example, is set in advance in the operational efficiency analysis unit 20.

The operational efficiency analysis unit 20 calculates the operational efficiency of each layer using the computation amount calculated from the parameters of the layers in the input neural network structure information and the execution time estimate of the layers. Namely, the operational efficiency is calculated by the following equation (1).

$$Operational efficiency = computation amount / execution time estimate \qquad ( 1 )$$

In the following explanation and in FIG. 4, the value of operational efficiency is shown as the value calculated by equation (1) divided by 1,000,000.

The higher the value of operational efficiency, the more calculations can be performed per unit of time. In other words, the higher the value of operational efficiency, the more efficient.

The computation amount can be easily calculated from the parameters of the layer. For example, the operational efficiency analysis unit 20 can calculate the computation amount of the convolution layer (Type=Conv) using equation (2).

$$Computation amount = {2}^{*} I {W}^{*} I {H}^{*} I {C}^{*} O {C}^{*} K {S}^{*} KS / ST / ST / GR \qquad ( 2 )$$

It should be noted that one sum-of-products operation required in the convolution layer is counted as two operations (addition and multiplication). Therefore, the right side of equation (2) is prefixed with “2*”.

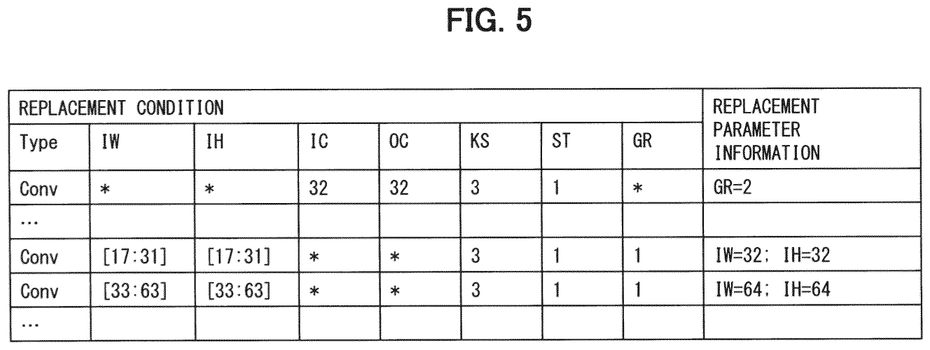

FIG. 5 is an explanatory diagram showing an example of layer replacement candidate information. Layer replacement candidate information is represented by a replacement condition consisting of a set of pairs of a replacement condition consisting of conditions for one or more parameters and replacement parameter information representing parameters after the change. The layer structure replacement unit 30 attempts to replace each layer in the operational efficiency information in the order described below. Replacement means replacing the parameters indicated in the corresponding replacement parameter information when the replacement conditions included in the layer replacement candidate information are satisfied.

For example, the replacement condition for the first line in FIG. 5 is that Type is Conv, IC and OC are 32, KS is 1, and ST is 1. In FIG. 5, “*” indicates that any value is matched. In the first line in FIG. 5, IW, IH, and GR are *. Therefore, this condition means that it holds true for any IW, IH, and GR values. In the first line in FIG. 5, it represents that the layer structure replacement unit 30 sets the parameter GR to 2 when this replacement condition is satisfied.

In FIG. 5, the notation [A:B] indicates an any value between A and B. For example, the replacement condition illustrated in the third line in FIG. 5 is satisfied when IW and IH are each a value between 17 and 31. In this case, it represents that the layer structure replacement unit 30 sets IW and IH to 32. The replacement condition illustrated in the fourth line in FIG. 5 is satisfied when IW and IH are each a value between 33 and 63. In this case, it represents that the layer structure replacement unit 30 sets IW and IH to 64.

The above example is based on the round-up operation. However, layer replacement candidate information may be expressed in other forms. For example, it may be possible to express more complex conditions by expressing them in conditional statements in programming languages such as C or Python (registered trademark).

Next, the order in which the layer structure replacement unit 30 performs layer replacement is explained. For example, the layer structure replacement unit 30 attempts to replace layers in the order of the layers in the operational efficiency information, starting with layers with large execution time estimates and low operational efficiency.

Specifically, the layer structure replacement unit 30 examines the operational efficiency in order from the layer with the largest execution time estimate. The layer structure replacement unit 30 attempts to replace a layer using layer replacement candidate information for the layer for which the operational efficiency is below a threshold. The threshold is set in advance. For example, it is set to 15.0 as a preferred value. The threshold may be gradually increased from a lower value.

As an example, the following describes the operation when the threshold is set to 15.0. In FIG. 4, the layer with the largest execution time estimate is the layer with ID=1 (Layer 1). The operational efficiency of Layer 1 is 3.4. Namely, the operational efficiency is below the threshold of 15.0. Therefore, the layer structure replacement unit 30 attempts to replace the layer. This layer fits the replacement conditions shown in the first line of FIG. 5. The layer structure replacement unit 30 replaces this layer with a layer whose parameter GR is 2.

The next layer with the largest execution time estimate is Layer ID=3 (Layer 3). The operational efficiency of Layer 3 is 21.4. Namely, the operational efficiency exceeds the threshold. Therefore, the layer structure replacement unit 30 does not replace layers with layer replacements.

The next layer with the largest execution time estimate is Layer ID=4 (Layer 4). The operational efficiency of Layer 4 is 3.2. Namely, the operational efficiency is below the threshold. Therefore, the layer structure replacement unit 30 attempts to replace the layer. However, since there are no applicable replacement conditions in the example shown in FIG. 5, the layer structure replacement unit 30 does not actually replace the layers.

Thus, the layer structure replacement unit 30 evaluates the operational efficiency in order from the layer with the largest execution time estimate and attempts to replace the layer. However, in some cases, such as the layer with layer ID=4, layer replacement is not performed even if the operational efficiency is below the threshold.

The layer structure replacement unit 30 may evaluate only those layers whose execution time estimates are above a certain threshold, instead of evaluating all layers. This is because for layers with considerably small execution time estimates, even if layer replacement is performed, the effect on the execution speed of the entire neural network is insignificant. For example, 1% of the sum of the execution time estimates of all layers may be used as the threshold.

In the above explanation, the number of layers before and after replacement was one, but it is not limited to that. For example, the layer structure replacement unit 30 may replace one layer with multiple layers or multiple layers with one layer. For example, three layers consisting of 1×1 convolution, 3×3 convolution, and 1×1 convolution, known as Depthwise-Separable Convolution, may be replaced by a regular 3×3 convolution, and vice versa. This example is an effective layer replacement for devices Depthwise-Separable Convolution is not good at.

The layer replacement candidate information may also include information that results in multiple replacement conditions for a given layer. In such a case, the layer structure replacement unit 30 generally selects a replacement that increase the operational efficiency of the replaced layer. However, the layer structure replacement unit 30 may make other selections. For example, the layer structure replacement unit 30 may select a replacement that reduces the execution time estimate even if the operational efficiency decreases. The operational efficiency of the replaced layer can be obtained from the target device characteristic information.

In order to maintain the expected recognition accuracy as much as possible, when replacing a layer, the layer structure replacement unit 30 may evaluate the similarity of the structure of the layer before replacement and replace so that the structure has a high similarity. As an example, when there is a replacement condition that sets the number of groups to 16 and a replacement condition that sets the number of groups to 8 for a layer with a group number GR of 32, it is conceivable to select a replacement that sets the number of groups to 16 with as little change in the number of groups as possible. The determination condition for determining a high degree of similarity is, in this example, a condition of the highest degree of similarity, but it is not limited to that. For example, the determination condition may be a condition of exceeding a predetermined threshold.

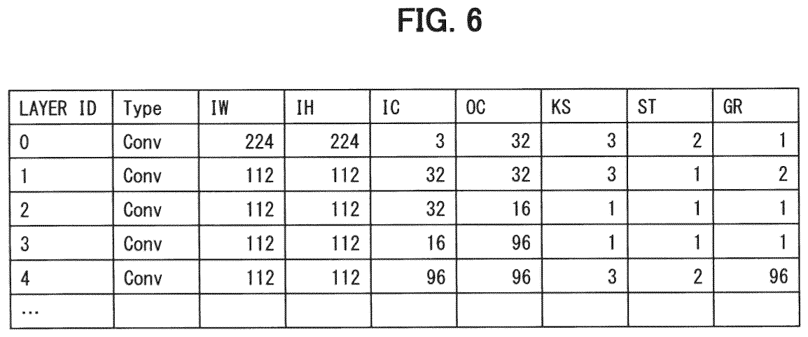

FIG. 6 is an explanatory diagram showing an example of output neural network structure information. Referring to the input neural network structure information shown in FIG. 2, the number of groups GR of the layer with layer ID=1 is replaced from 32 to 2. Referring to FIG. 3, the execution time estimate of the layer with layer ID=1 after the replacement is 1.4. The operational efficiency is 82.6. The operational efficiency is an improvement from the operational efficiency of 3.4 for the layer with layer ID=1 shown in FIG. 4.

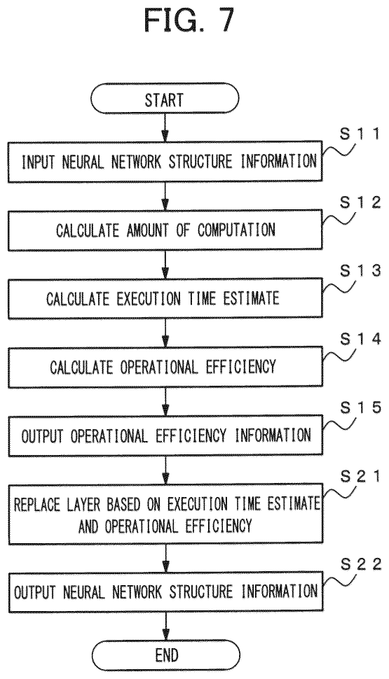

Next, the operation of the neural network structure proposal device 10 is explained with reference to the flowchart in FIG. 7.

The neural network structure information is input to the operational efficiency analysis unit 20 (step S11). The operational efficiency analysis unit 20 calculates a computation amount from the parameters for each of multiple layers of the input neural network with different parameters, using (2) above, for example (step S12). For each of the multiple layers, the operational efficiency analysis unit 20 calculates the execution time estimate using parameters of each layer in the input neural network structure information and referring to the corresponding execution time in the target device characteristic information (step S13).

The operational efficiency analysis unit 20 calculates, for example, using (1) above, operational efficiency from the calculated computation amount and the execution time estimate (step S14). The operational efficiency analysis unit 20 provides the operational efficiency to the layer structure replacement unit 30 (step S15).

The layer structure replacement unit 30 replaces layers with reference to the layer replacement candidate information (refer to FIG. 5), targeting layers with large execution time estimates in the operational efficiency information (refer to FIG. 4) and low operational efficiency (step S21). The layer structure replacement unit 30 outputs the neural network structure information with the layers replaced as output neural network structure information (step S22).

As explained above, in this example embodiment, the operational efficiency analysis unit 20 analyzes the structure of a given neural network and estimates the operational efficiency of each layer in the neural network on the target device. The layer structure replacement unit 30 replaces layers with high operational efficiency, which are prepared in advance, in order from the layer with a large amount of operations and low operational efficiency. Then, the layer structure replacement unit 30 outputs the neural network structure replaced with an alternative layer structure (a layer whose parameters are different from those of the original layer). Thus, the neural network structure proposal device 10 can output a neural network structure suitable for the target device.

In this example embodiment, since a neural network structure suitable for the target device can be obtained, the execution speed can be improved while maintaining recognition accuracy in edge devices with limited calculation resources. As an example, this example embodiment can be applied to an application such as speeding up an object detection system using a camera.

In the above example embodiment, the layer structure replacement unit 30 performed layer replacement based on a round-up operation. The round-up operation may be advantageous in terms of execution speed depending on the target device. For example, for devices that are not good at processing layers with a spatial size that is not a power of 2, it may be advantageous in terms of execution speed to round up to a spatial size that is a power of 2, even if the spatial size is larger. Equivalent processing can be achieved when the spatial size is increased. It is also expected that recognition accuracy will improve as the spatial size increases. However, it may be advantageous to reduce the spatial size. For example, although a smaller spatial size may cause some degradation in recognition accuracy, it may be possible to reduce the spatial size in order to prioritize the improvement of execution speed.

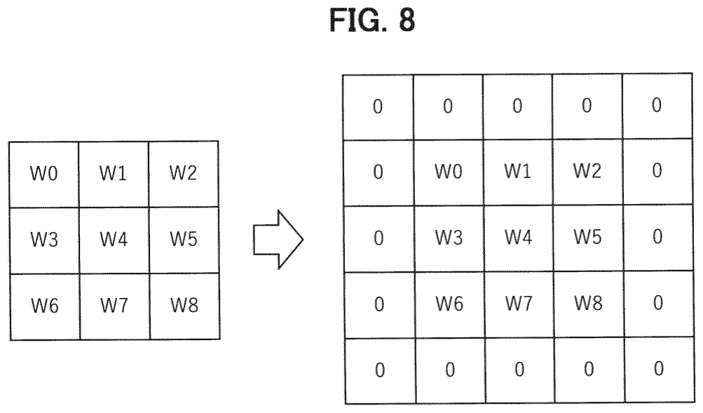

As another example, consider the case of changing the kernel size KS. When the kernel size KS is increased, in general, equivalent processing can be achieved to that before the kernel size KS is changed. For example, when changing a 3×3 convolutional kernel to a 5×5 convolutional kernel, if we place the weights W0 to W8 of the 3×3 convolutional kernel shown in left side of FIG. 8 as weights of the 5×5 convolutional kernel as shown in right side of FIG. 8, it becomes an equivalent convolution operation. In addition, if the area where the weights are zero in right side of FIG. 7 is utilized by re-training, the recognition accuracy is expected to be improved.

When degradation of recognition accuracy is to be avoided, the layer replacement candidate information may be configured so that only logically equivalent conversions are possible, such as changing from 3×3 convolution to 5×5 convolution or reducing the number of groups GR.

The output of the neural network structure proposal device 10 is the modified neural network structure. The output of the neural network structure proposal device 10 does not include learned weights, etc. In other words, if there are already learned weights, the learned weights may be reused as illustrated in FIG. 8. The neural network structure proposal device 10 may also relearn the weights after reuse. The neural network structure proposal device 10 may also relearn from the beginning using random weights, etc., without using the learned weights.

In the above example embodiments, it is assumed that the layer structure replacement unit 30 performs replacements that improve operational efficiency. However, it is not limited to replacements that improve operational efficiency. For example, layer replacement candidate information that emphasizes energy efficiency may be stored in the layer replacement candidate information storage unit 50. Also, layer replacement candidate information that emphasizes recognition accuracy may be stored in the layer replacement candidate information storage unit 50.

The neural network structure proposal device 10 of the above example embodiment may be configured with a piece of hardware or a piece of software. Part of the components in the above example embodiment may be configured with hardware and the other part with software.

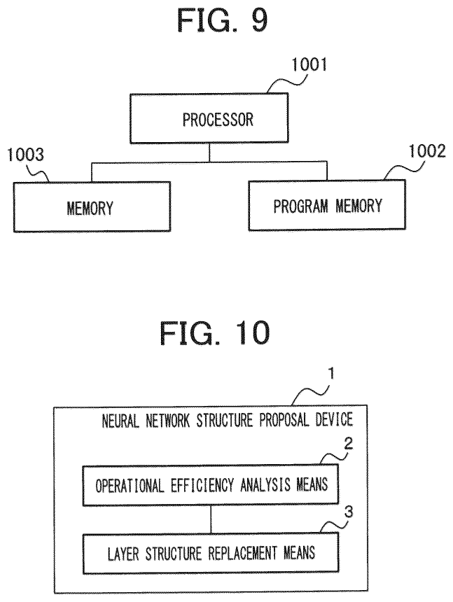

FIG. 9 is a block diagram showing a configuration example of an information processing device that can realize the functions of the neural network structure proposal device. The information processing device shown in FIG. 9 includes one or more processors such as one or more CPUs (Central Processing Units), a program memory 1002, and a memory 1003. FIG. 9 shows an example of an information processing device having one processor 1001.

The program memory 1002 is, for example, a non-transitory computer readable medium. The non-transitory computer readable medium is one of various types of tangible storage media. For example, as the program memory 1002, a semiconductor storage medium such as a flash ROM (Read Only Memory) or a magnetic storage medium such as a hard disk can be used. In the program memory 1002, a neural network structure proposal program for realizing functions of blocks (the operational efficiency analysis unit 20, the layer structure replacement unit 30) in the neural network structure proposal device 10 of the above example embodiment is stored.

The processor 1001 realizes the neural network structure proposal device 10 by executing processing according to the neural network structure proposal program stored in the program memory 1002. When multiple processors are implemented, they can also work together to realize the function of the neural network structure proposal device 10.

A transitory computer readable medium such as a RAM (Random Access Memory), for example can be used as the memory 1003. In the memory 1003, temporary data, etc., that is generated when the neural network structure proposal device 10 executes processing are stored.

It can also be assumed that the neural network structure proposal program is stored in a temporary computer readable medium. In that case, the neural network structure proposal program is transferred to the memory 1003, for example, through a wired or wireless communication channel, i.e., through electric signals, optical signals, or electromagnetic waves.

The processor 1001 then executes processing based on the neural network structure proposal program in the memory 1003.

The program memory 1002 and the memory 1003 may be integrated into a single unit. The target device characteristic information storage unit 40 and the layer replacement candidate information storage unit 50 shown in FIG. 1 can be realized by the memory 1003.

FIG. 10 is a block diagram showing the main part of the neural network structure proposal device. The neural network structure proposal device 1 shown in FIG. 10 calculates, for each of multiple layers of neural networks with different parameters (e.g., layers ID0 to ID4 shown in FIG. 2), the estimated amount of execution time of the layer and the calculation amount per unit time on the target device. The operational efficiency analysis method 2 (in the example embodiment, realized by the operational efficiency analysis unit 20) calculates the operational efficiency corresponding to the estimated execution time of the layer and the computation amount per unit time on the target device for each of multiple layers (e.g., layers ID0 to ID4 shown in FIG. 2).) and layer structure replacement means 3 (in the example embodiment, this is realized by the layer structure replacement part 3 0 is realized in the implementation) and is equipped with the following.

Layer structure replacement method 3 may be configured to attempt to replace layers whose operational efficiency is below a threshold in descending of the largest estimated amount of execution time.

The target device characteristic information may be provided with first storage means (e.g., target device characteristic information storage unit 40) for storing target device characteristic information including information indicating at least the execution time of each layer in the target device, and the operational efficiency analysis means 2 may be configured to calculate an estimated amount of execution time by referring to the execution time in the target device characteristic information.

The layer structure replacement means 3 may be configured to perform layer replacement by referring to the layer replacement candidate information, The layer structure replacement means 3 may be configured to perform layer replacement by referring to the layer replacement candidate information.

A part of or all of the above example embodiments may also be described as, but not limited to, the following supplementary notes.

### (Supplementary Note 1) a Neural Network Structure Proposal Device, Comprising:

operational efficiency analysis means for calculating, for each of a plurality of layers of a neural network having different parameters, an estimated amount of execution time of the layer and operational efficiency corresponding to the computation amount per unit time on ae target device, and
layer structure replacing means for replacing the layer with the large estimated amount of execution time and low operational efficiency with another layer, and outputting neural network structure information indicating structure of the neural network.

### (Supplementary Note 2) the Neural Network Structure Proposal Device of Supplementary Note 1, Wherein

the layer structure replacing means attempts to replace the layer for which the operational efficiency is below a threshold in descending order of of the estimated amount of execution time.

### (Supplementary Note 3) the Neural Network Structure Proposal Device of Supplementary Note 1 or 2, Wherein

the operational efficiency analysis means calculates the estimated amount of execution time and the operational efficiency for input neural network structure information.

### (Supplementary Note 4) the Neural Network Structure Proposal Device of One of Supplementary Notes 1 to 3, Comprising

a first storage that stores target device characteristic information including at least information indicating the execution time of each layer in the target device, wherein
the operational efficiency analysis means calculates the estimated amount of execution time with reference to the execution time in the target device characteristic information.

### (Supplementary Note 5) the Neural Network Structure Proposal Device of One of Supplementary Notes 1 to 4, Comprising

a second storage that stores layer replacement candidate information represented by a replacement condition consisting of a set of pairs of a replacement condition consisting of conditions for one or more parameters and replacement parameter information representing parameters after the change, wherein
the layer structure replacing means replaces the layer with reference to the layer replacement candidate information.

### (Supplementary Note 6) the Neural Network Structure Proposal Device of One of Supplementary Notes 1 to 5, Wherein

the layer structure replacing means replaces the layer in the neural network structure with a layer such that a similarity between a structure of the layer before replacement and the structure of the layer after replacement satisfies a predetermined decision condition.

### (Supplementary Note 7) a Neural Network Structure Proposal Method, Comprising:

calculating, or each of multiple layers of a neural network having different parameters, an estimated amount of execution time of the layer and operational efficiency of the layer corresponding to a computation amount per unit time on a target device, and
replacing the layer with the large estimated amount of execution time and low operational efficiency with another layer, and output neural network structure information indicating structure of the neural network.

### (Supplementary Note 8) the Neural Network Structure Proposal Method of Supplementary Note 7, Further Comprising

attempting to replace the layer for which the operational efficiency is below a threshold in descending order of of the estimated amount of execution time.

### (Supplementary Note 9) the Neural Network Structure Proposal Method of Supplementary Note 7 or 8, Further Comprising

calculating the estimated amount of execution time with reference to the execution time in the target device characteristic information stored in a first storage that stores target device characteristic information including at least information indicating the execution time of each layer in the target device.

### (Supplementary Note 10) the Neural Network Structure Proposal Method of One of Supplementary Notes 7 to 9, Further Comprising

replace the layer with reference to the layer replacement candidate information stored in a second storage that stores layer replacement candidate information represented by a replacement condition consisting of a set of pairs of a replacement condition consisting of conditions for one or more parameters and replacement parameter information representing parameters after the change.

### (Supplementary Note 11) a Neural Network Structure Proposal Program for Causing a Computer to Execute:

calculating, or each of multiple layers of a neural network having different parameters, an estimated amount of execution time of the layer and operational efficiency of the layer corresponding to a computation amount per unit time on a target device, and
replacing the layer with the large estimated amount of execution time and low operational efficiency with another layer, and output neural network structure information indicating structure of the neural network.

### (Supplementary Note 12) the Neural Network Structure Proposal Program of Supplementary Note 11, Wherein

the neural network structure proposal program causes the computer to execute
attempting to replace the layer for which the operational efficiency is below a threshold in descending order of of the estimated amount of execution time.

### (Supplementary Note 13) a Computer Readable Storage Medium for Storing a Neural Network Structure Proposal Program for Causing a Computer to Execute:

calculating, or each of multiple layers of a neural network having different parameters, an estimated amount of execution time of the layer and operational efficiency of the layer corresponding to a computation amount per unit time on a target device, and
replacing the layer with the large estimated amount of execution time and low operational efficiency with another layer, and output neural network structure information indicating structure of the neural network.

### (Supplementary Note 14) the Computer Readable Storage Medium of Supplementary Note 13, Wherein

the neural network structure proposal program causes the computer to execute
attempting to replace the layer for which the operational efficiency is below a threshold in descending order of of the estimated amount of execution time.

1. A neural network structure proposal device, comprising:
a memory storing a software instruction, and
one or more processors configured to execute the software instruction to
calculate, for each of multiple layers of a neural network having different parameters, an estimated amount of execution time of the layer and operational efficiency of the layer corresponding to a computation amount per unit time on a target device, and
replace the layer with the large estimated amount of execution time and low operational efficiency with another layer, and output neural network structure information indicating structure of the neural network.

2. The neural network structure proposal device according to claim 1, wherein
the one or more processors are configured to execute the software instructions to attempt to replace the layer for which the operational efficiency is below a threshold in descending order of of the estimated amount of execution time.

3. The neural network structure proposal device according to claim 1, wherein
the one or more processors are configured to execute the software instruction to calculate the estimated amount of execution time and the operational efficiency for input neural network structure information.

4. The neural network structure proposal device according to claim 2, wherein
the one or more processors are configured to execute the software instruction to calculate the estimated amount of execution time and the operational efficiency for input neural network structure information.

5. The neural network structure proposal device according to claim 1, comprising
a first storage that stores target device characteristic information including at least information indicating the execution time of each layer in the target device, wherein
the one or more processors are configured to execute the software instruction to calculate the estimated amount of execution time with reference to the execution time in the target device characteristic information.

6. The neural network structure proposal device according to claim 2, comprising
a first storage that stores target device characteristic information including at least information indicating the execution time of each layer in the target device, wherein
the one or more processors are configured to execute the software instruction to calculate the estimated amount of execution time with reference to the execution time in the target device characteristic information.

7. The neural network structure proposal device according to claim 5, comprising
a second storage that stores layer replacement candidate information represented by a replacement condition consisting of a set of pairs of a replacement condition consisting of conditions for one or more parameters and replacement parameter information representing parameters after the change, wherein
the one or more processors are configured to execute the software instruction to replace the layer with reference to the layer replacement candidate information.

8. The neural network structure proposal device according to claim 6, comprising
a second storage that stores layer replacement candidate information represented by a replacement condition consisting of a set of pairs of a replacement condition consisting of conditions for one or more parameters and replacement parameter information representing parameters after the change, wherein
the one or more processors are configured to execute the software instruction to replace the layer with reference to the layer replacement candidate information.

9. The neural network structure proposal device according to claim 1, wherein
the one or more processors are configured to execute the software instructions to replace the layer in the neural network structure with a layer such that a similarity between a structure of the layer before replacement and the structure of the layer after replacement satisfies a predetermined decision condition.

10. The neural network structure proposal device according to claim 2, wherein
the one or more processors are configured to execute the software instructions to replace the layer in the neural network structure with a layer such that a similarity between a structure of the layer before replacement and the structure of the layer after replacement satisfies a predetermined decision condition.

11. A neural network structure proposal method implemented in a computer, comprising:
calculating, or each of multiple layers of a neural network having different parameters, an estimated amount of execution time of the layer and operational efficiency of the layer corresponding to a computation amount per unit time on a target device, and
replacing the layer with the large estimated amount of execution time and low operational efficiency with another layer, and output neural network structure information indicating structure of the neural network.

12. The neural network structure proposal method according to claim 11, wherein
the computer attempts to replace the layer for which the operational efficiency is below a threshold in descending order of of the estimated amount of execution time.

13. A non-transitory computer readable storage medium for storing a neural network structure proposal program for causing a computer to execute:
calculating, or each of multiple layers of a neural network having different parameters, an estimated amount of execution time of the layer and operational efficiency of the layer corresponding to a computation amount per unit time on a target device, and
replacing the layer with the large estimated amount of execution time and low operational efficiency with another layer, and output neural network structure information indicating structure of the neural network.

14. The non-transitory computer readable storage medium according to claim 13, wherein
the neural network structure proposal program causes the computer to execute
attempting to replace the layer for which the operational efficiency is below a threshold in descending order of of the estimated amount of execution time.
